(19) United States
(12) Patent Application Publication
(10) Pub. No.: US 2026/0348217 A1
(43) Pub. Date: Nov. 5, 2026

(54) ADJUSTABLE MOUNTING SYSTEM FOR HYDRAULIC DOOR

(71) Applicant: Kinze Manufacturing, Inc., Williamsburg, IA (US)

(72) Inventor: Arlen Seeman, Williamsburg, IA (US)

(21) Appl. No.: 19/468,289

(22) Filed: Feb. 3, 2026

Related U.S. Application Data
(60) Provisional application No. 63/752,962, filed on Feb. 3, 2025.

(51) Int. Cl. E05F 15/53; E06B 3/38; E06B 3/70; E06B 3/72; E06B 7/22

(52) U.S. Cl. CPC E05F 15/53; E06B 3/38; E06B 3/72; E06B 7/22; E06B 2003/7044

(57) ABSTRACT

A hydraulic door for use in buildings such as warehouses, hangars, or barns, wherein the hydraulic door includes an ability to adjust position with relation to surrounding adjacent structure of the door between the door and the floor, in addition to being a standalone structure capable of supporting itself without a surrounding building. The hydraulic door further includes mounts that enable the adjusting of a bottom position of hydraulic cylinders that are used with the door.

### CROSS REFERENCE TO RELATED APPLICATIONS

This application claims priority under 35 U.S.C. § 119(e) to provisional patent application U.S. Ser. No. 63/752,962, filed Feb. 3, 2025. The provisional patent application is hereby incorporated by reference in its entirety herein, including without limitation: the specification, claims, and abstract, as well as any figures, tables, appendices, or drawings thereof.

### TECHNICAL FIELD

The present disclosure relates generally to a hydraulic actuated door having applications in at least the agriculture, aviation, and automotive industries. More particularly, but not exclusively, the present disclosure relates to an adjustable mounting system for a hydraulic door in which industries that use large doors for a hangar to store large items may utilize the system described herein to actuate closing or opening of these large hangar doors. Examples include but are not limited to warehouses or barns that store large agricultural vehicles and/or implements, hangars for airports storing airplanes therein, and garages storing vehicles not limited only to personal use but also for example in mechanics' shops.

### BACKGROUND

The background description provided herein gives context for the present disclosure. Work of the presently named inventors, as well as aspects of the description that may not otherwise qualify as prior art at the time of filing, are neither expressly nor impliedly admitted as prior art.

Large buildings that use large doors may in various circumstances use a hydraulic cylinder to actuate opening and closing of the door. Structures that utilize this type of system include but are not limited to warehouses or barns that store large agricultural vehicles and/or implements, hangars for airports storing airplanes therein, and garages storing vehicles not limited only to personal use but also for example in mechanics' shops. Doors used in industry for these structures have problems that users of the structure must put up with. One such example is working in the structure on a vehicle, be it a warehouse or hangar, in which it is below freezing temperatures outside and the large door is opened to allow entry of the vehicle therein. If the large door is installed at anything other than perfectly aligned with surrounding structure, then the large door when shut will have openings between it and the surrounding structure, thus allowing undesirable cold air to enter the warehouse or hangar in which users are working therein. In order to fix these hydraulic doors of the industry, a base portion of the hydraulic cylinder which is actuated to open the large door is often welded directly to the large door. Thus, in order to adjust a position of the door with relation to the hydraulic actuators the weld must be broken which is time consuming in and of itself, and then rewelded while holding the large door in place, hoping that the door will not move out of place during the weld thus making the open cracks near the surrounding structure even worse than they were before adjusting the large door to reduce open airways for cold air to enter the warehouse or hangar.

Other problems that exist with hydraulic doors in the industry include: use of cam rollers at a point of motion with the hydraulic cylinder which cause high-wear points; semi-regular to regular maintenance required on the hydraulic door at a position high above the ground that is difficult to access (10-30 feet up and even more in given industries); and custom made hydraulic cylinders being required for replacement parts or production/manufacture in conjunction with the large door due to how the different large doors in the industry were designed to work.

Thus, there exists a need in the art for a hydraulic door which may be easily adjusted when the door is askew with the ground, in addition to requiring less maintenance and repair.

### SUMMARY

The following objects, features, advantages, aspects, and/or embodiments are not exhaustive and do not limit the overall disclosure. No single embodiment need provide each and every object, feature, or advantage. Any of the objects, features, advantages, aspects, and/or embodiments disclosed herein can be integrated with one another, either in full or in part.

It is a primary object, feature, and/or advantage of the present disclosure to improve on or overcome the deficiencies in the art.

It is a further object, feature, and/or advantage of the present disclosure to allow for easy adjusting of a hydraulic door's position with relation to surrounding adjacent structure with relation to ground.

It is still yet a further object, feature, and/or advantage of the present disclosure to reduce wear in addition to reducing required maintenance on hydraulic doors through superior design.

It is still yet a further object, feature, and/or advantage of the present disclosure to create a hydraulic door that is easily assembled for users of the hydraulic door.

It is preferred the apparatus be safe, cost effective, and durable.

The hydraulic door can be incorporated into systems or kits which accomplish some or all of the previously stated objectives.

According to some aspects of the present disclosure, a hydraulic door that includes a frame, wherein the frame includes a horizontal portion, two vertical portions positioned at each of a distal ends of the horizontal portion, and extending in a same direction from the horizontal portion, wherein each of the two vertical portions include a post; a foot at a bottom of the post; a frame-V extending outwardly from an upper portion of the post shaped as a “V”, wherein an apex of a shape of the frame-V is positioned furthest away from the post; and a shelf positioned on a lower portion of the post. Wherein the hydraulic door further includes a door, the door including a top portion, two side portions extending positioned at each of a distal ends of the top portion, and extending in a same direction from the top portion, a bottom portion extending between the distal ends of the two side portions opposite the top portion, and a plate positioned in between each of the top portion, the two side portions, and the bottom portion, wherein each of the two side portions includes a door-V extending outwardly from an upper portion of the side portion shaped as a “V”, wherein an apex of a shape of the door-V is positioned furthest away from the side portion. Wherein the hydraulic door further includes two mounts, wherein the two mounts are separately and removably attached to the two vertical portions adjacent the shelf of each of the two vertical portions, and the two mounts each include a plurality of elongated apertures on a base portion of the two mounts. Further the hydraulic doors includes two bottom hydraulic pins, wherein the two bottom hydraulic pins separately extend through the two mounts. Furthermore, the hydraulic door includes two hydraulic cylinders, wherein the two hydraulic cylinders separately attach to the two bottom hydraulic pins. Further still the hydraulic door includes two top hydraulic pins, wherein the two top hydraulic pins separately extend into the each of the door-V and the two hydraulic cylinders separately attach to the two top hydraulic pins. Additionally, the hydraulic door includes two pivot pins separately extending through each of the door-V and the frame-V, connecting the door-V and the frame-V on a first side of the hydraulic door, and connecting the door-V and the frame-V on a second side of the hydraulic door, and placing the door and the frame in rotational communication.

According to some additional aspects of the present disclosure, a greaseless bushings surrounding the pivot pins interfacing between the pivot pins and the door-V and the pivot pins and the frame-V.

According to some additional aspects of the present disclosure, a pivot pin housing on the door-V and a pivot pin-housing on the frame-V to house the pivot pin over a portion of the pivot pin that extends between the door-V and the frame-V.

According to some additional aspects of the present disclosure, a plurality of plates, a plurality of horizontal supports, and further comprising a plurality of vertical supports, wherein the plurality of horizontal supports and the plurality of vertical supports in combination form a grid-like structure in between the top portion, the two side portions, and the bottom portion for the plurality of plates to be positioned in between.

According to some additional aspects of the present disclosure, top seals securely fastened to the two side portions of the door via top seal retainers, and bottom seals securely fastened to vertical portions of the frame via bottom seal retainers.

According to some additional aspects of the present disclosure, each of the top seal retainers and the bottom seal retainers comprise a sheet of material which sandwich the top seals and the bottom seals respectively to the door and the frame respectively in which bolts are inserted through the top seal retainer and the top seal to be secured to the door and bolts are inserted through the bottom seal retainer and the bottom seal to be secured to the frame, thus sealing an interface between the door and the frame when the door is in a closed position.

According to some additional aspects of the present disclosure, a floor seal attached to the bottom portion for sealing an interfacing between a bottom of the door and the ground.

According to some other aspects of the present disclosure, a kit for a hydraulic door, comprising: a frame including: a horizontal portion; two vertical portions; wherein each of the two vertical portions comprise: a post; a foot at a bottom of the post; a frame-V extending outwardly from an upper portion of the post shaped as a “V”, wherein an apex of a shape of the frame-V is positioned furthest away from the post; and a shelf positioned on a lower portion of the post; a door including: a top portion; two side portions; a bottom portion; and a plate; wherein each of the two side portions includes a door-V extending outwardly from an upper portion of the side portion shaped as a “V”, wherein an apex of a shape of the door-V is positioned furthest away from the side portion; two mounts, the two mounts each comprising a base with two walls extending a same direction from the base, wherein the base includes a plurality of elongated apertures and each of the walls includes a pin aperture in coincident alignment with one another; two bottom hydraulic pins; two hydraulic cylinders; two top hydraulic pins; and two pivot pins.

According to some additional aspects of the present disclosure, a floor seal.

According to some additional aspects of the present disclosure, two top seals, two bottom seals, two top seal retainers, and two bottom seal retainers.

According to some additional aspects of the present disclosure, a plurality of plates, plurality of horizontal supports, and a plurality of vertical supports.

According to some additional aspects of the present disclosure, a plurality of linchpins.

According to some additional aspects of the present disclosure, a plurality of greaseless bushings.

These and/or other objects, features, advantages, aspects, and/or embodiments will become apparent to those skilled in the art after reviewing the following brief and detailed descriptions of the drawings. The present disclosure encompasses (a) combinations of disclosed aspects and/or embodiments and/or (b) reasonable modifications not shown or described.

### BRIEF DESCRIPTION OF THE DRAWINGS

Several embodiments in which the present disclosure can be practiced are illustrated and described in detail, wherein like reference characters represent like components throughout the several views. The drawings are presented for exemplary purposes and may not be to scale unless otherwise indicated.

FIG. 1 shows a perspective view of a hydraulic door in an open position according to aspects of the present disclosure.

FIG. 2 shows a perspective view of the hydraulic door of FIG. 1 in a closed position according to aspects of the present disclosure.

FIG. 3 shows a side elevation view of the hydraulic door of FIG. 1 according to aspects of the present disclosure.

FIG. 4 shows an enlarged portion of the side elevation view of FIG. 3.

FIG. 5 shows a back elevation view of an enlarged portion of the hydraulic door of FIG. 1 according to aspects of the present disclosure.

FIG. 6 shows a side elevation view depicting a trajectory of rotation for a pin of the hydraulic door with a hydraulic cylinder of the hydraulic door shown in two separate and overlapping positions, according to aspects of the present disclosure.

FIG. 7A shows a side elevation view of a mount according to aspects of the present disclosure.

FIG. 7B shows a back elevation view of the mount of FIG. 6A according to aspects of the present disclosure.

FIG. 8 shows a side elevation view of the hydraulic door according to aspects of the present disclosure.

FIG. 9 shows an enlarged portion of FIG. 7.

FIG. 10 shows a back elevation view of a hydraulic door depicting a modularity of the hydraulic door of FIG. 1 according to aspects of the present disclosure.

FIG. 11 shows a back elevation view of a hydraulic door that acts as a roadmap for a Bill of Materials to be used in conjunction with Table 1 of the present disclosure, in which all figures that follow FIG. 11 are pieces of FIG. 11 in a standalone figure without the other components or materials shown in FIG. 11.

FIG. 12A shows a side elevation view of a vertical portion of a frame according to aspects of the present disclosure.

FIG. 12B shows a back elevation view of the vertical portion of FIG. 12A.

FIG. 13A shows a side elevation view of a horizontal portion of the frame according to aspects of the present disclosure.

FIG. 13B shows a back elevation view of the horizontal portion of FIG. 13A.

FIG. 14A shows an elevation view of a pivot pin according to aspects of the present disclosure.

FIG. 14B shows a plan view of the pivot pin of FIG. 14A.

FIG. 15A shows a plan view of a retaining ring according to aspects of the present disclosure.

FIG. 15B shows an elevation view of the retaining ring.

FIG. 16A shows a back elevation view of a top portion of a door according to aspects of the present disclosure.

FIG. 16B shows a bottom plan view of the top portion of FIG. 16A.

FIG. 17A shows a side elevation view of a side portion of the door according to aspects of the present disclosure.

FIG. 17B shows a back elevation view of the side portion of FIG. 17A.

FIG. 18A shows a top plan view of a bottom portion of the door according to aspects of the present disclosure.

FIG. 18B shows a back elevation view of the bottom portion of FIG. 18A.

FIG. 19 shows an internal brace for the door according to aspects of the present disclosure.

FIG. 20A shows the mount of FIGS. 6A-6B but in a section of the figures shown in conjunction with FIG. 11.

FIG. 20B shows the mount of FIGS. 6A-6B but in a section of the figures shown in conjunction with FIG. 11.

FIG. 21 shows a back elevation view of a top rubber seal for the door according to aspects of the present disclosure.

FIG. 22A shows a side elevation view of a top seal retainer for the rubber seal of FIG. 21 according to aspects of the present disclosure.

FIG. 22B shows a back elevation view of the top seal retainer of FIG. 22A.

FIG. 23A shows a side elevation view of a middle seal retainer according to aspects of the present disclosure.

FIG. 23B shows a back elevation view of the seal retainer of FIG. 23A.

FIG. 24 shows a bottom rubber seal for the door according to aspects of the present disclosure.

FIG. 25A shows a side elevation view of a bottom seal retainer for the door according to aspects of the present disclosure.

FIG. 25B shows a back elevation view of the bottom seal retainer of FIG. 25A.

FIG. 26 shows a plan view of a top cap rubber seal according to aspects of the present disclosure.

FIG. 27A shows a plan view of a top cap seal retainer according to aspects of the present disclosure.

FIG. 27B shows an elevation view of the top cap seal retainer of FIG. 27A.

FIG. 28A shows a side elevation view of a floor seal retainer according to aspects of the present disclosure.

FIG. 28B shows a top elevation view of the floor seal retainer of FIG. 28A.

FIG. 29A shows atop plan view of a vertical internal brace for the door according to aspects of the present disclosure.

FIG. 29B shows a side elevation view of the vertical internal brace of FIG. 29A.

FIG. 30 shows a top elevation view of a floor seal according to aspects of the present disclosure.

An artisan of ordinary skill in the art need not view, within isolated figure(s), the near infinite distinct combinations of features described in the following detailed description to facilitate an understanding of the present disclosure.

### DETAILED DESCRIPTION

The present disclosure is not to be limited to that described herein. Mechanical, electrical, chemical, procedural, and/or other changes can be made without departing from the spirit and scope of the present disclosure. No features shown or described are essential to permit basic operation of the present disclosure unless otherwise indicated.

Unless defined otherwise, all technical and scientific terms used above have the same meaning as commonly understood by one of ordinary skill in the art to which embodiments of the present disclosure pertain.

The terms “a,” “an,” and “the” include both singular and plural referents.

The term “or” is synonymous with “and/or” and means any one member or combination of members of a particular list.

As used herein, the term “exemplary” refers to an example, an instance, or an illustration, and does not indicate a most preferred embodiment unless otherwise stated.

The term “about” as used herein refers to slight variations in numerical quantities with respect to any quantifiable variable. Inadvertent error can occur, for example, through use of typical measuring techniques or equipment or from differences in the manufacture, source, or purity of components.

The term “substantially” refers to a great or significant extent. “Substantially” can thus refer to a plurality, majority, and/or a supermajority of said quantifiable variables, given proper context.

The term “generally” encompasses both “about” and “substantially.”

The term “configured” describes structure capable of performing a task or adopting a particular configuration. The term “configured” can be used interchangeably with other similar phrases, such as constructed, arranged, adapted, manufactured, and the like.

Terms characterizing sequential order (e.g., first, second, third), a position, and/or an orientation are not limiting and are only referenced according to the views presented.

When an element is referred to as being “connected,” “coupled,” “mated,” “attached,” “fixed,” etc. to another element, the element can be directly connected to the other element, or intervening elements may be present. In contrast, when an element is referred to as being “directly connected,” “directly coupled,” etc. to another element, there are no intervening elements present. Other words used to describe the relationship between elements should be interpreted in a like fashion (e.g., “between” versus “directly between,” “adjacent” versus “directly adjacent,” etc.). Similarly, terms such as (i) “communicatively connected” or (ii) “fluidly connected” include (i) all variations of information exchange and routing between two electronic devices, including intermediary devices, networks, etc., connected wirelessly or not and (ii) all variations of fluid exchange and routing between two fluidic bodies, including intermediary fluid paths, flows, etc., connected indirectly or not.

The “invention” is not intended to refer to any single embodiment of the particular invention but encompass all possible embodiments as described in the specification and the claims. The “scope” of the present disclosure is defined by the appended claims, along with the full scope of equivalents to which such claims are entitled. The scope of the disclosure is further qualified as including any possible modification to any of the aspects and/or embodiments disclosed herein which would result in other embodiments, combinations, subcombinations, or the like that would be obvious to those skilled in the art.

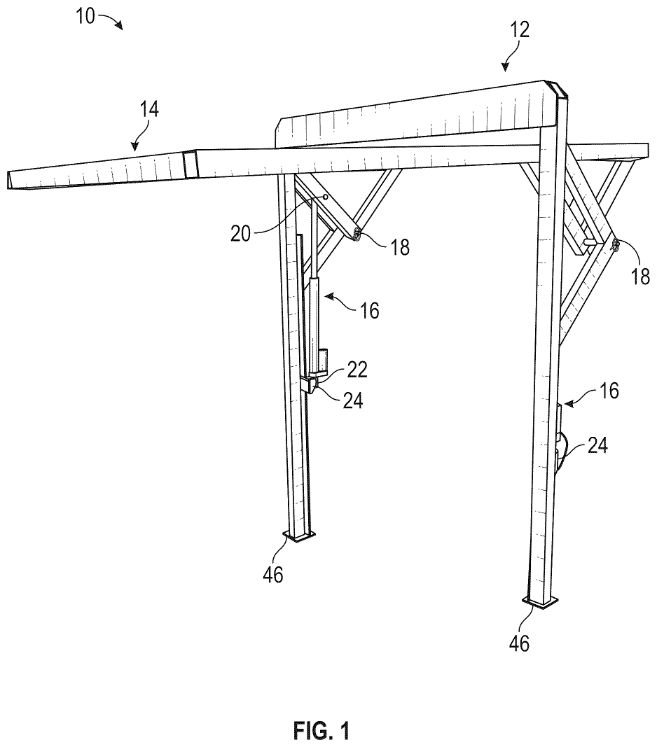

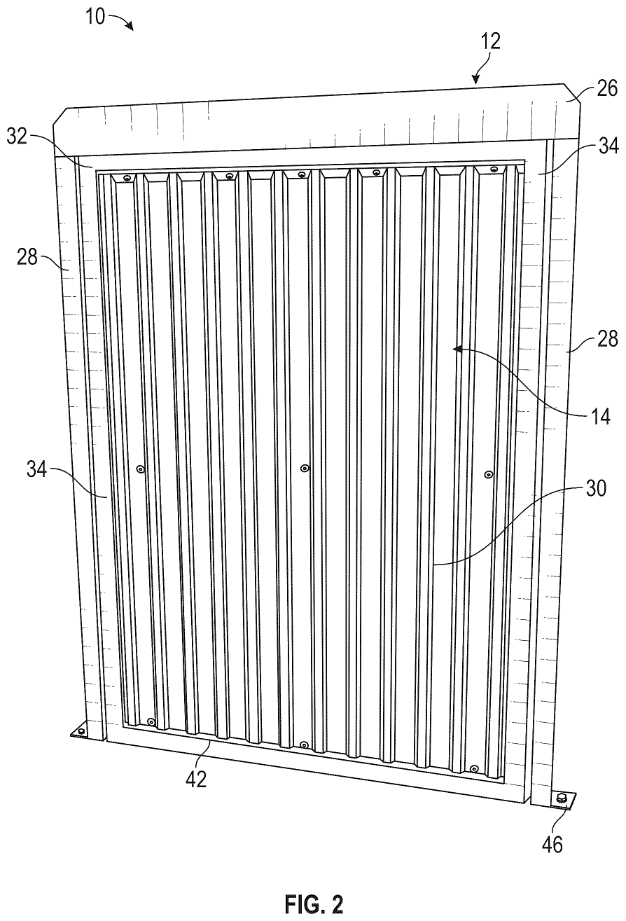

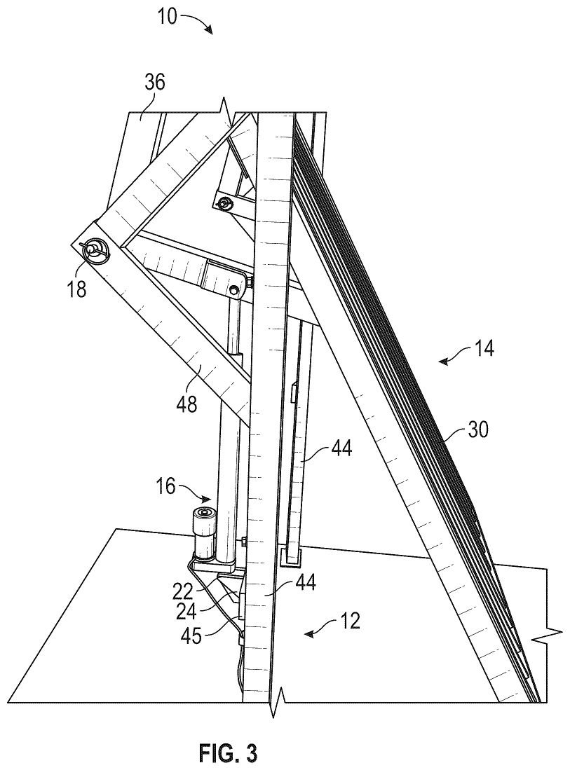

FIGS. 1-2 show a hydraulic door 10, and FIGS. 3-5 show enlarged portions of the hydraulic door 10. The hydraulic door 10 includes a frame 12, a door 14, hydraulic cylinders 16, pivot pins 18, top hydraulic pins 20, bottom hydraulic pins 22, and mounts 24. The frame 12 includes a top horizontal portion 26, and two vertical portions 28. The door 14 includes an interior plate 30, a top portion 32, two side portions 34 each including a door-V 36 which includes both a pivot pin housing 38 and a hydraulic pin housing 40, and the door 14 further includes a bottom portion 42. The vertical portions 28 each include a post 44, a shelf 45, a foot 46, a frame-V 48 including a pivot pin housing 50. The hydraulic door 10 may further include linchpins 52, top seals 54 including top seal retainers 56, bottom seals 58 including bottom seal retainers 60, horizontal supports (not shown), vertical supports (not shown), an upper seal (not shown), a floor seal (not shown), and greaseless bushings (not shown).

To assemble the hydraulic door, the frame 12 connects to the door 14 via the hydraulic cylinders 16 and the pivot pins 18, in which the hydraulic cylinders 16 connects to the door 14 via the top hydraulic pins 20 and connects to the frame 12 via the bottom hydraulic pins 22 via the mount 24. More specifically, a horizontal portion 26 of the frame 12 is positioned on top of two vertical portions 28, fixedly attached forming 90-degree angles at distal ends of the horizontal portion 26, thus forming a stand-alone frame 12 for the door 14 to be positioned within. The door 14 is assembled via attaching to the interior plate 30 the top portion 32 at the top of the plate 30, the two side portions 32 on either side of the plate 30, and the bottom portion 42 on a bottom of the plate 30 so as to secure the plate 30 or an interior of the door 14. The door 14 can include horizontal supports therein and vertical supports therein so as to bolster a strength of the door, but also to allow for separating the plate 30 into a plurality of plates 30 which will be shown in later figures. On each of the side portions 34 the door-V 36 exists at an upper half of the side portions 34, forming a V-shape to allow for connection points of the pivot pin 18 and the top hydraulic pin 20.

More specifically, the pivot pin 18 is positioned at an apex of the door-V 36, extends horizontally through the door-V 36, and extends through an apex position of the frame-V 48 on the vertical portion 28 of the frame 12, in which the frame-V 48 extends from the post 44, and the post 44 is fixedly attached to a floor via the feet 42. These pivot pins 18 (one on each side of the frame 12) act as a point of rotation for the door 14. In this regard, the pivot pin 18 acts as a medium of connection between the frame 12 and the door 14.

An additional medium of connection between the frame 12 and the door 14 is the hydraulic cylinder 16. This is accomplished via attaching a top of the hydraulic cylinder 16 to the door-V 36 via the upper hydraulic pin 20 thus placing the hydraulic cylinder 16 in rotational communication with the door-V 36 and attaching a bottom of the hydraulic cylinder 16 to the mount 24 via the bottom hydraulic pin 20 thus allowing for rotational communication at the bottom of the hydraulic cylinder 16 as well.

The mount 24 directly attaches to the post 44 of the vertical portion 28 thus acting as yet an additional medium of connection between the frame 12 and the door 14. The mount 24 is removably attached to the frame 12 via being positioned on the shelf 45 which is positioned on a lower half of the post 44.

Further, the upper hydraulic pin 20 extends into door-V 36 at a position between the apex of the door-V 36 and a lower end of the door-V 36, while also extending through the top of the hydraulic cylinder 16.

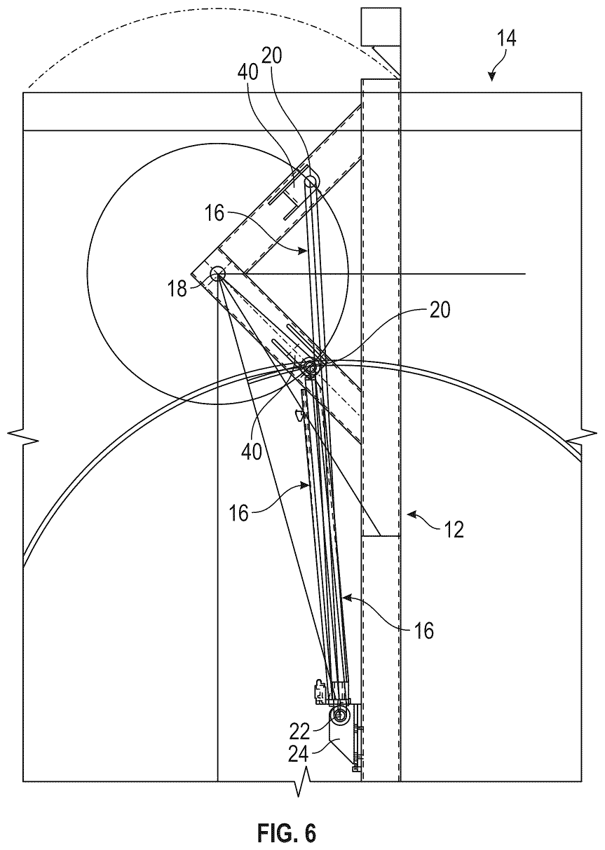

As such, when the hydraulic door 10 is fully assembled, the hydraulic door 14 will be in rotational communication with the frame 12 via connection points at the pivot pins 18, the top hydraulic pins 20, and the bottom hydraulic pins 22. This is represented in FIG. 6 which shows overlapping first positions of the hydraulic cylinder 16 at a first, closed-door position and a second, fully-open-door position. As shown, the pivot pin 18 remains in a same position throughout rotation of the door, while the top hydraulic pin 20 moves in an arc (following a circular pattern of movement) as the hydraulic cylinder 16 is actuated from a completely retracted position to an extended position. The pivot pin 18 and the top hydraulic pin 20 remain a set distance between one another which causes the door 14 to rotate from being urged at the top hydraulic pins 20 location. In this regard, the door may rotate between a vertical and a horizontal position while being capable of stopping at any position therebetween (from zero to ninety degrees).

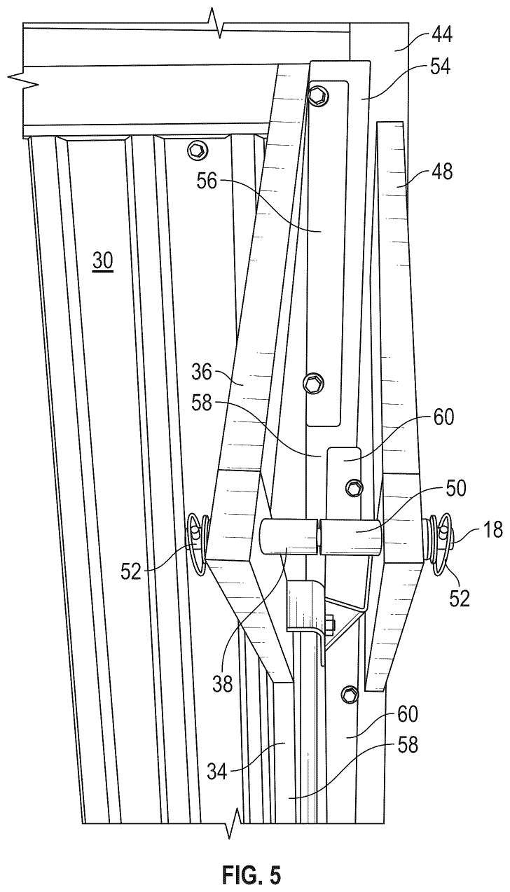

Furthermore, the pivot pin 18 may extend through the door-V 36 and the frame-V 48 via the pivot pin housing 38 and the pivot pin housing 50 which can most easily be seen in FIG. 5. The pivot pin 18 may include apertures therethrough at distal ends of the pivot pin 18 so as to allow for insertion of linchpins 52 at each end thereof.

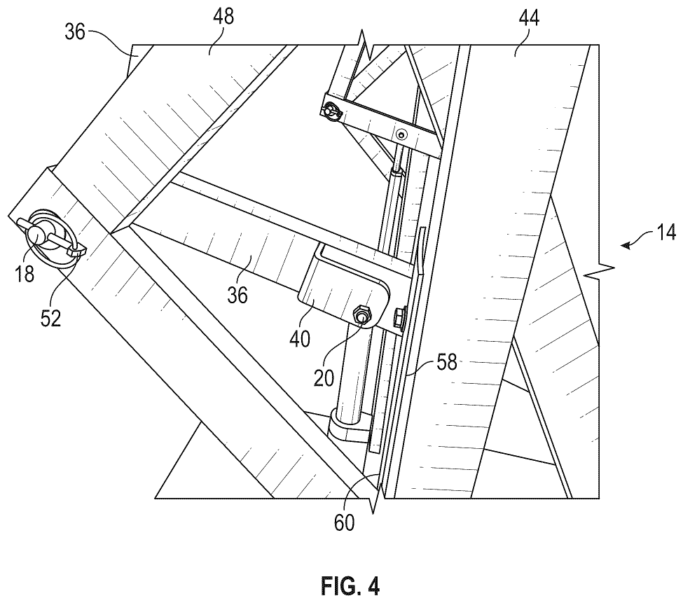

Moreover, the hydraulic door 10 includes the top seals 54 including top seal retainers 56, and the bottom seals 58 including bottom seal retainers 60. As shown in FIGS. 4-5, the top seals 54 are secured to the door 14 and move with the door 14 as the door rotates. The bottom seals 58 on the other hand are connected to the frame 12. In this regard, the separation point between the top seal and the bottom seal is substantially aligned with the pivot pin 18 which separates a position of the door 14 that will rotate backwards versus rotating forward (with relation to the frame having a back and a front). The top seal retainer 56 secures the seal 54 to the door, and the bottom seal retainer 60 secures the bottom seal 58 to the frame 12. Thus, when the door 14 is in the closed position, the seals 54, 58 assist with keep the air at a front of the hydraulic door 10 and air at a back of the hydraulic door 10 separated.

There are numerous benefits to the disclosed design. With this design, different sizes of door can be used differing both in vertical height and horizontal width. This is because with the design of the present disclosure, the top hydraulic pins 20 always remain in the same place on the door 14 throughout rotation of the door 14, the pivot pins 18 always remain in the same place during rotation of the door 14, and a bottom of the hydraulic cylinders remain at a fixed position at the mounts 24 on the shelves 45 of the frame 12. Thus, a same stroke cylinder can be used for different height doors thus allowing for variable size doors while using the same hydraulic cylinder. This is because the shelf 45 on the vertical portion 26 (to which the mount 24 and thus a bottom point of rotation for the hydraulic cylinder) is always the same vertical distance from the pivot pin 18 and the top hydraulic pin 20 is always the same distance from the pivot pin 18. This benefits both manufacturers and consumers by reducing a need for custom sized hydraulic cylinders and thus simplifies assembly for the user in addition to repair for replacement parts should the hydraulic cylinder need replacing, in addition to being able to use standard industry sized hydraulic cylinders. If a change in size of the door is too drastic (e.g., 10 feet to 50 feet), then of course a stronger hydraulic cylinder with a bigger bore cylinder would need to be used, but with such drastic change additional structural changes would be made to the hydraulic door such as changing a size of the frame-V 48 (making it larger to balance out a moment placed on the hydraulic door 10 when the door 14 is in a horizontal position) and the door-V 36 which would alter a distance from the pivot pin 18 and the to hydraulic pin 20.

Further, because of this pivoting design of the hydraulic door 10, there are fewer parts required in the design than traditional hydraulic doors thus increasing ease of installation and assembly while reducing an amount of breakable parts reducing maintenance and repair. In traditional hydraulic doors cam rollers are used within a track which creates high wear points whereas the present disclosure provides rotation simply via the pivot pins 18 and the hydraulic pins 20 which greatly reduces an amount of wear placed on the system. Furthermore, cam rollers moved in a track can require oiled or greased maintenance which can be near a ceiling of a building and difficult to reach up high on these large hydraulic doors in addition to traditional hydraulic doors using bearings that require regular greasing. Because the hydraulic door 10 only uses pins to rotate, this allows for use of greaseless bushings surrounding the pivot pin 18, the top hydraulic pin 20, and the bottom hydraulic pin 22 thus eliminating maintenance for greasing roller bearings.

Additionally, the design of this hydraulic door 10 acts in and of itself as a standalone structure. In this regard, the hydraulic door 10 may be placed and used in any properly-shaped opening of a building without requiring support from the building itself to be usable. The frame 12 may be fixedly attached to the floor or ground via anchoring bolts placed through the feet 46 of the frame 12. The feet 46 may be larger in width for taller doors so as to help counteract a moment that the door-V 36 and the frame-V 48 place on the hydraulic door 10 when in the closed position, and to counteract a moment that the door 14 places on the hydraulic door 10 when in the fully open position.

Not only are there simplification in installation benefits in addition to being usable in a greater variety of buildings due to this standalone characteristic of the hydraulic door 10, but because of this standalone nature of the hydraulic door 10 the hydraulic door 10 may also support surrounding structure in which the hydraulic door 10 is placed. If this is desirable and intended when choosing where to place the hydraulic door 10 within a building, then the horizontal portion 26 will be properly chosen to be a robust, thicker, and sturdier horizontal portion 26 capable of sustaining weight rather than a thinner horizontal portion 26 that is designed only to connect the vertical portions 28 of the frame 12 while reducing unnecessary weight of the hydraulic door 10. In this regard, the hydraulic door 10 is capable of strengthening surrounding structure and strengthening a sturdiness of a wall of the building in which the hydraulic door 10 is installed.

Moreover, there are benefits of the present disclosure relating to installing and assembly due to the modularity of the hydraulic door 10 which will be described further herein in conjunction with other figures.

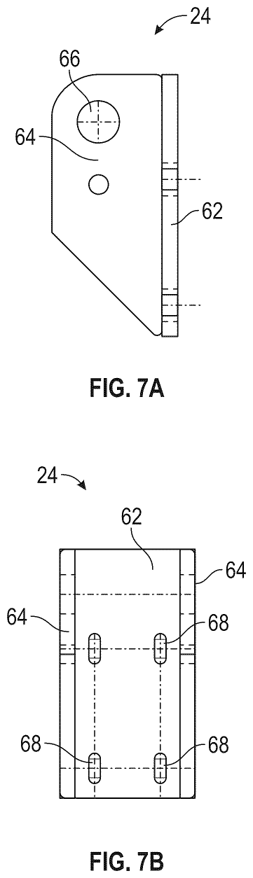

Finally, a significant advantage over traditional hydraulic doors exists with the present disclosure being able to adjust a door's position with relation to surrounding adjacent structure via the mount 24. Shown in FIGS. 7A-7B is the mount 24 in additional detail. The mount 24 includes a base 62, walls 64, pin apertures 66, and mounting apertures 68.

The base 62 directly interfaces with the post 44 of the frame 12, and the walls 64 extend substantially perpendicular from the base 62. The bottom hydraulic pin 20 extends through the pin apertures 66, in which the bottom of the hydraulic cylinder 16 is placed between the walls 64 and around the bottom hydraulic pin 20. Due to the nature of this connection, the hydraulic cylinder 16 may be easily detached (such as via linchpins inserted through apertures at distal ends of the bottom hydraulic pin 20 that can be removed, thus allowing for removal of the bottom hydraulic pin 20 from the mount 24, or in the alternative nuts at the distal ends of the bottom hydraulic pin 20 in which the bottom hydraulic pin 20 would include threaded connections at the distal ends), and then a position of the mount 24 may be adjusted with relation to the frame 12. The position of the mount 24 may be adjusted on the post 44 of the frame 12 specifically because of the elongated nature of mounting apertures 68. As shown in FIG. 7B, the mount 24 includes four mounting apertures 68. The mounting apertures 68 being elongated in nature allows for play in where fasteners are positioned through the mounting apertures 68. Namely, insertion of fasteners through the mount 24 and into the post 44 and/or shelf 45 of the frame 12 (in which receiving apertures within the shelf 45 are not adjustable) makes it so that the fasteners such as anchors, bolts, screws, etc. are immoveable, but the mount 24 may be moved up or down along these fasteners that are inserted through the non-cylindrical and elongated mounting apertures 68.

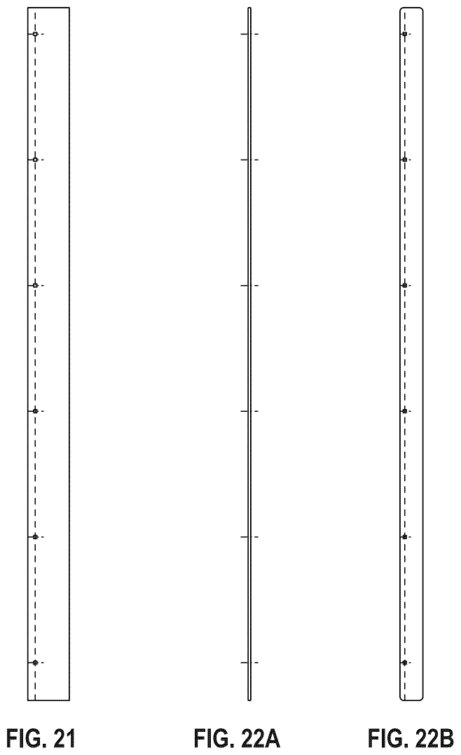

In this regard, lowering the mount 24 would lower the hydraulic cylinder 16 and the position of top hydraulic pin 20. This would cause the door 14 to rotate against the top seal 54 and the bottom seal 58 (also shown as rubber seals shown in FIGS. 21 and 24), thus increasing the compression of the rubber to improve the seal between the door 14 and the frame 12. Thus, raising the mount 24 would raise the hydraulic cylinder 16 and the position of top hydraulic pin 20, and since the door 14 is locked to the position of pin 18 the door is forced to rotate about pin 18 in a clockwise direction. This adjustment would be done to prevent over-rotation of the door 14 into the seals causing damage, or to adjust the sealing at the sides of the door 14 to reduce airflow therethrough.

This is in opposition to traditional hydraulic doors in which an area of the connection point for the hydraulic cylinder is welded to the structure, and adjustment of the door requires severing the weld (because there was not mount equivalent that was removably attached to the structure) to adjust where a bottom of the hydraulic cylinder sits on the wall. This process for traditional doors requires holding the door to be securely held in place while the weld is being done making for a difficult process if any adjustment is needed to the door 14. With the present disclosure, the mount 24 provides ease in installation and adjustment of the door 14 with relation to the adjacent structure surrounding the door.

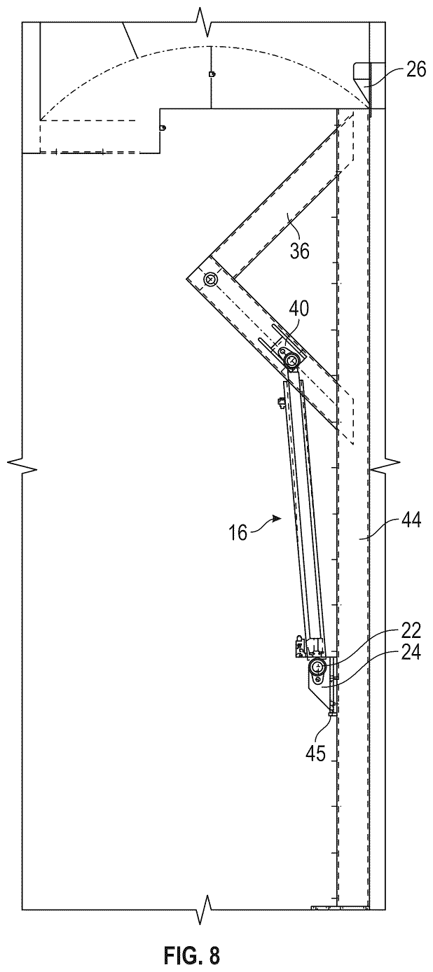

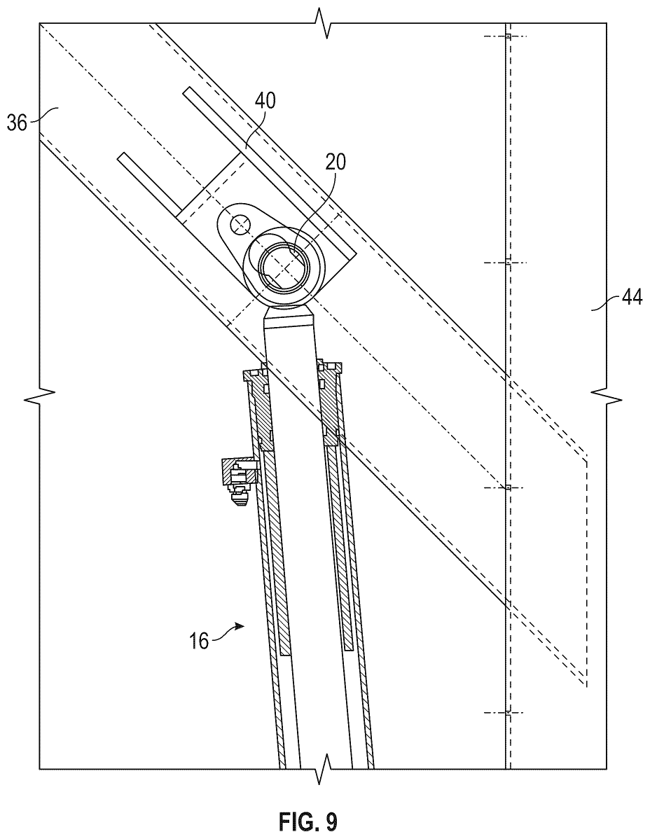

FIG. 8 shows an additional side elevation view of the hydraulic door 10 and FIG. 9 shows an enlarged portion of FIG. 8 to show additional detail of how the hydraulic cylinder 16 connects to door-V 36. As shown, top hydraulic pin 20 is inserted through a top of the hydraulic cylinder 16, and in conjunction with FIG. 4 it can be seen how this connection happens within the hydraulic pin housing 40 (in which the hydraulic pin housing 40 is an extension from the door-V 36 with a hollow or open area therebetween). The hydraulic pin housing 40 acts as a support or bolstering portion for connection of the hydraulic cylinder to the door-V 36. Similarly, the bottom hydraulic pin 22 can be seen in FIG. 8 extending through the mount 34 in which the bottom of the hydraulic cylinder surrounds the bottom hydraulic pin 22 like the top of the hydraulic cylinder 16 surrounds the top hydraulic pin 20.

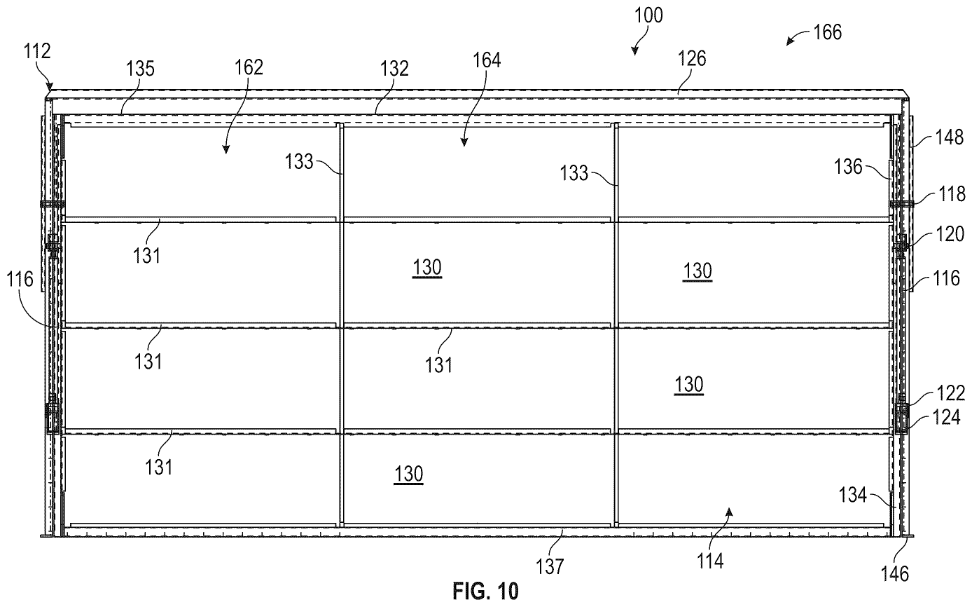

FIG. 10 shows a hydraulic door 100. The hydraulic door 100 includes a frame 112, a door 114, hydraulic cylinders 116, pivot pins 118, top hydraulic pins 120, bottom hydraulic pins 122, and mounts 124. The frame 112 includes a top horizontal portion 126, and two vertical portions 128. The door 114 includes interior plates 130, horizontal supports 131, a top portion 132, vertical supports 133, two side portions 134, an upper seal 135, a floor seal 137, and a bottom portion 142, in which the two side portions 134 each include a door-V 136 which includes both a pivot pin housing 138 and a hydraulic pin housing 140. The vertical portions 128 each include a post 144, a shelf 145, a foot 146, a frame-V 148 including a pivot pin housing 150. The hydraulic door 110 may further include linchpins 152, top seals 154 including top seal retainers 156, bottom seals 158 including bottom seal retainers 160, and greaseless bushings (not shown). Furthermore, the door 114 can be separated into a first column 162, a second column 164, and a third column 166, in addition to being separated into a plurality of rows. Thus, the hydraulic door 100 includes the same components as the hydraulic door 10 with the only exception being that the door 114 is larger and is separated into multiple interior plates 130 with horizontal supports 131 and vertical supports 133 therein which may separate the door plate 30 into multiple door plates 130 thus creating rows and columns within the door 114.

As such FIG. 10 shows how the door 14 can be broken into modular pieces so as to easily create larger doors by increasing the columns and rows within the door 114. To assemble the hydraulic door 100, everything is done the exact same as described above with the hydraulic door 10, except assembly of portions of the door 14, 114 contained within the top portion 32, 132, the side portions 34, 134, and the bottom portion 42, 142. With a larger door (e.g., the door 114), the door will utilize multiple plates 30, 130 which will be assembled and held together via the horizontal supports 131 and the vertical supports 133. It goes without saying that a wider door 114 will require a longer horizontal portion 126 of the frame 112 than a smaller door's 14 horizontal portion 26 and should there be increased rows or height to the door 14, then longer posts 144 and side portions 134 will be required, but as explained earlier, a same hydraulic cylinder 16, 116 may be used because of having the same stroke.

Further, it should be noted that FIG. 10 shows the floor seal 137. Should the levelness of the door 14 be askew with relation to the ground or floor (in which air may travel through openings between the door and the floor while the door is in the closed position), these gaps can be compensated for via adjusting a vertical position of the floor seal 137.

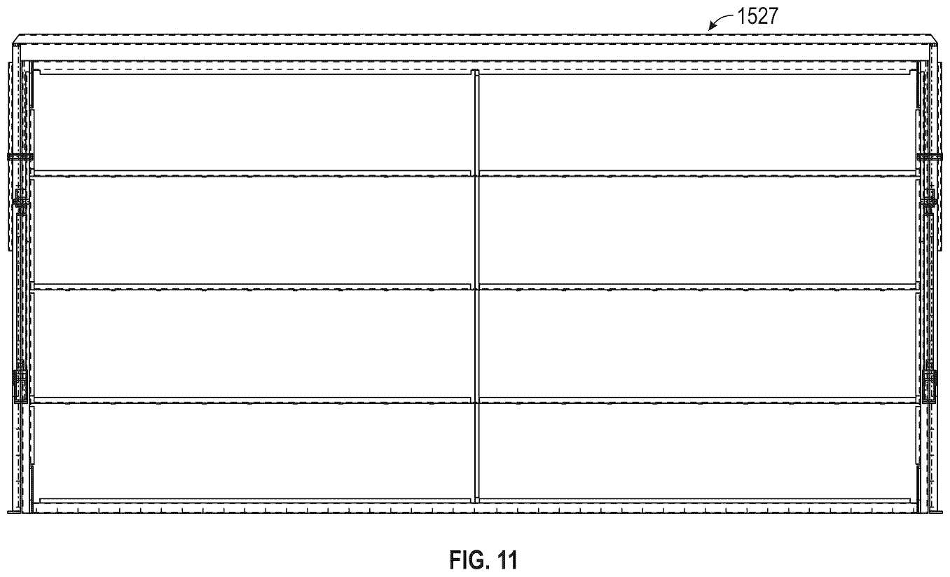

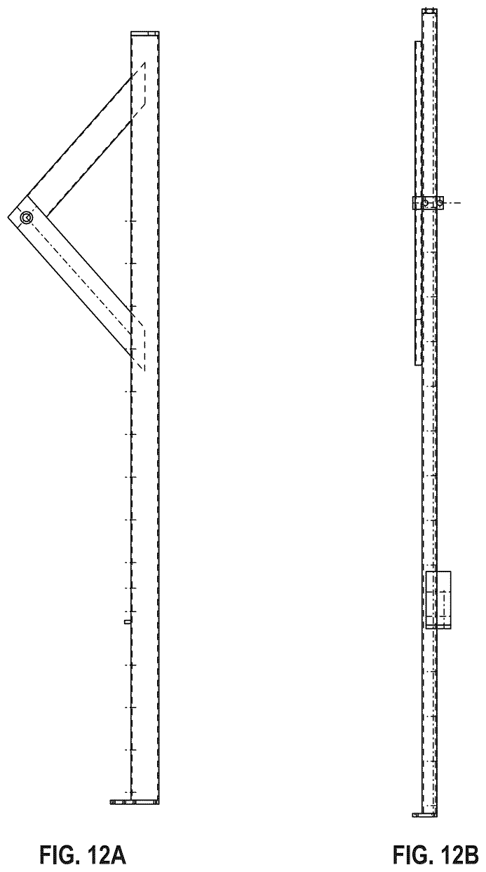

FIG. 11 shows an assembled hydraulic door 1527 to be used with Table 1 below acting as a bill of materials, wherein FIGS. 12A-30 show individual components of the hydraulic door 1527. Note that the hydraulic door 1527 includes only two columns as opposed to three columns of interior plates as opposed to FIG. 10 (thus providing another example of the modularity of the hydraulic door).

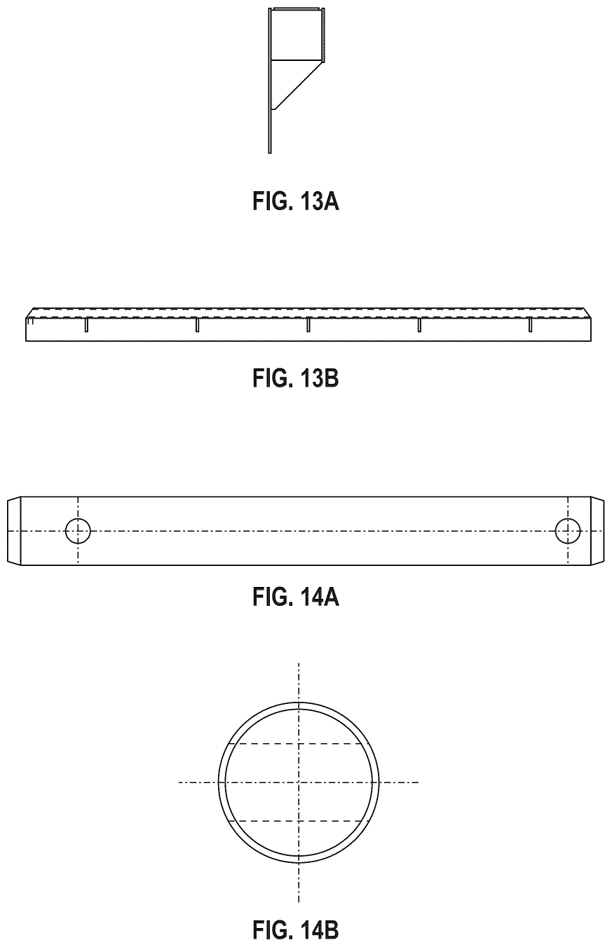

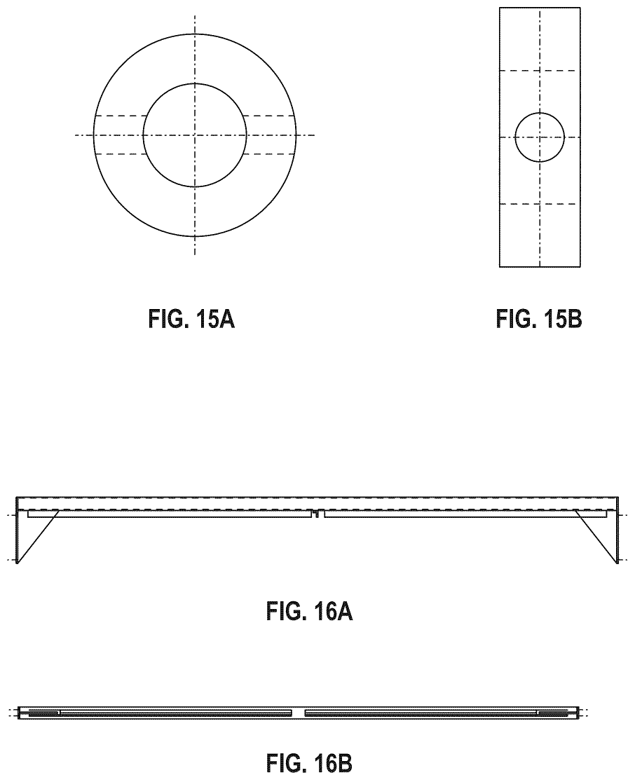

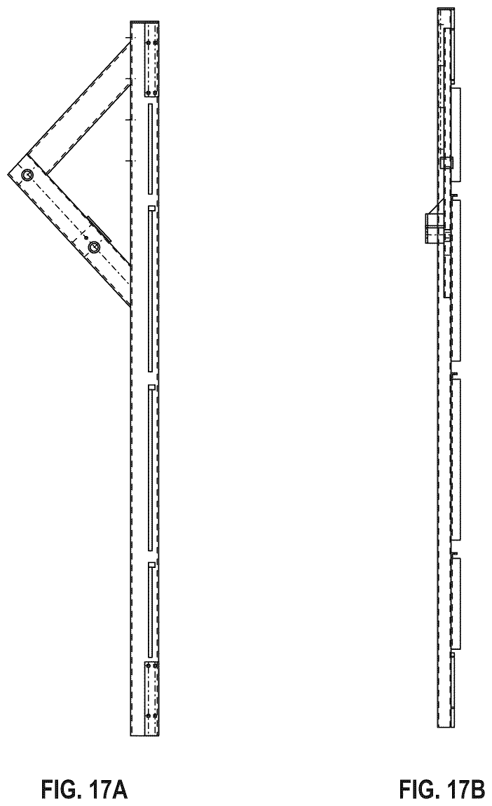

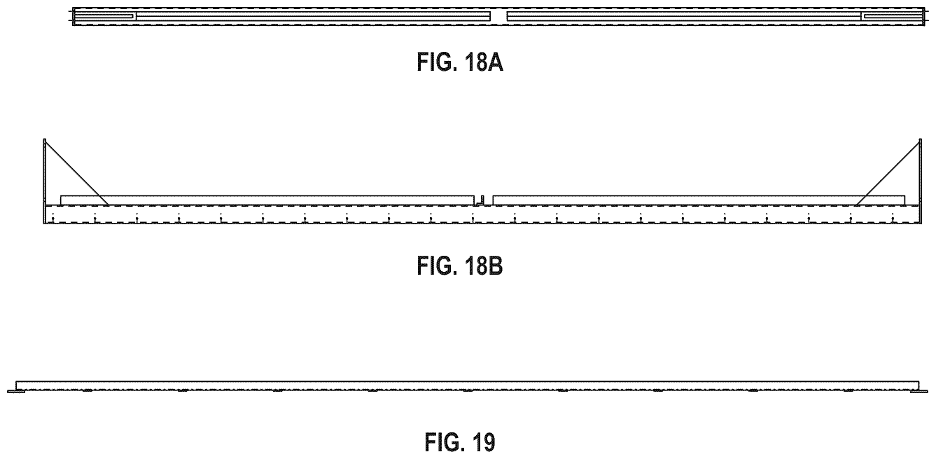

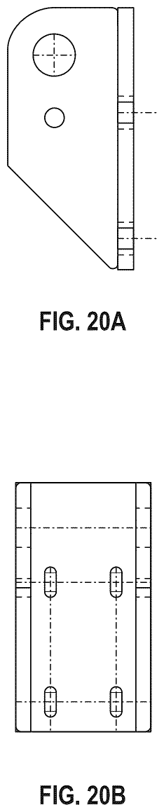

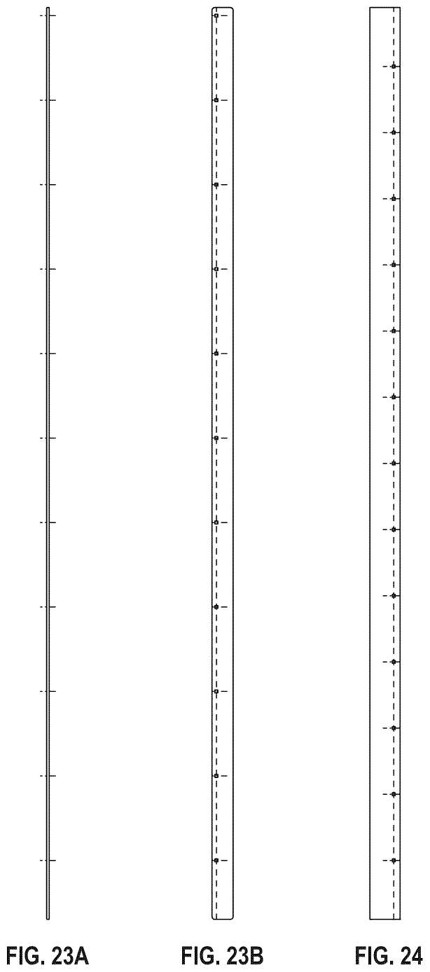

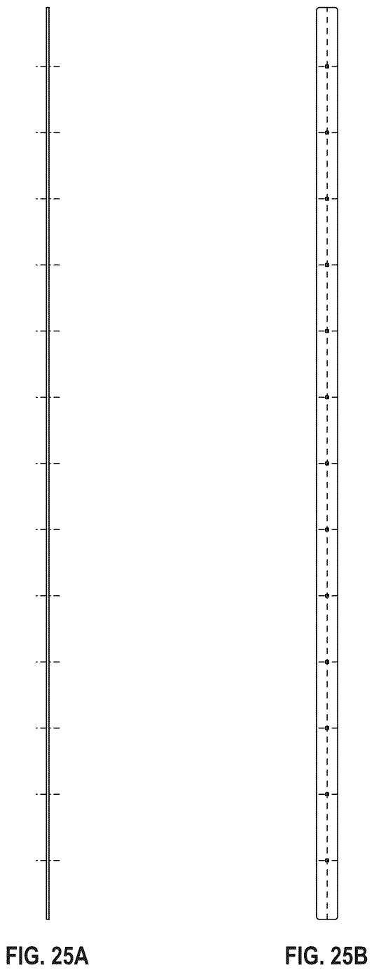

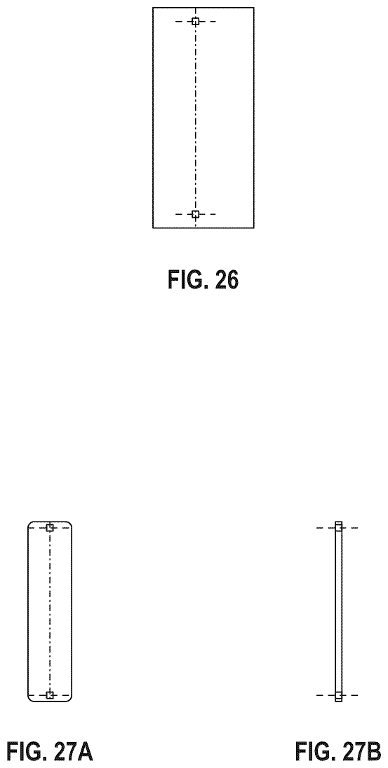

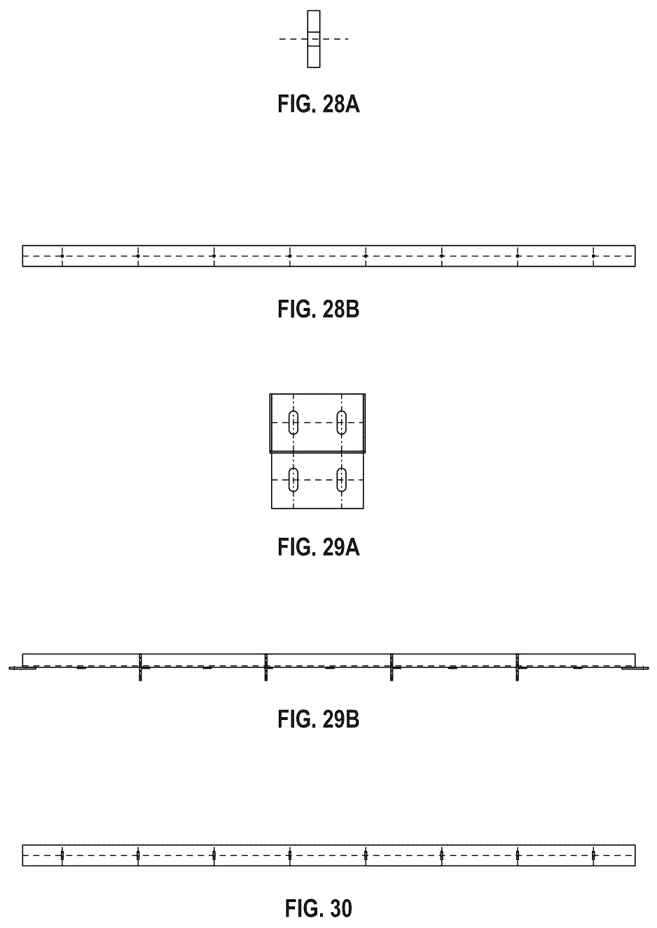

TABLE 1

| ITEM | QUANTITY | DESCRIPTION | FIGURE |
|---|---|---|---|
| 1 | 1 | FRAME - VERTICAL - LEFT (PART OF DOOR JAM) | FIG. 12A-12B |
| 2 | 1 | FRAME - VERTICAL - RIGHT (PART OF DOOR JAM) | FIG. 12A-12B |
| 3 | 1 | FRAME - HORIZONTAL | FIG. 13A-13B |
| 3A | 8 | Ø1/2-1 3 HHCS - 1.50 LONG (BOLT) | N/A |
| 3B | 8 | Ø1/2 WASHER | N/A |
| 4 | 2 | PIVOT PIN | FIG. 14A-14B |
| 5 | 4 | KEEPER BUSHING | N/A |
| SA | 4 | Ø1/2-13 HHCS - 4.00 LONG (BOLT) | N/A |
| SB | 4 | Ø1/2-13 NUT | N/A |
| 6 | 2 | RETAINING RING | FIG. 15A-15B |
| 6A | 2 | Ø1/2-13 HHCS - 4.00 LONG (BOLT) | N/A |
| 6B | 2 | Ø1/2-13 NUT | N/A |
| 7 | 1 | DOOR - VERTICAL - LEFT (PART OF DOOR) | FIG. 17A-17B |
| 7A | 1 | GREASELESS BUSHING | N/A |
| 8 | 1 | DOOR - VERTICAL - RIGHT (PART OF DOOR) | FIG. 17A-17B |
| 8A | 1 | GREASELESS BUSHING | N/A |
| 9 | 1 | DOOR - HORIZONTAL - TOP (PART OF DOOR) | FIG. 16A-16B |
| 9A | 8 | Ø1/2-13 HHCS - 2.00 LONG (BOLT) | N/A |
| 9B | 8 | Ø1/2 WASHER | N/A |
| 10 | 1 | DOOR - HORIZONTAL - BOTTOM (PART OF DOOR) | FIG. 18A-18B |
| 10A | 8 | Ø1/2-13 HHCS - 2.00 LONG (BOLT) | N/A |
| 10B | 8 | Ø1/2 VV ASH E R | N/A |
| 11 | 12 | INTERNAL BRACE - HORIZONTAL | FIG. 19 |
| 11A | 48 | Ø1/2-13 HHCS - 1.50 LONG (BOLT) | N/A |
| 11B | 96 | Ø1/2 WASH E R | N/A |
| 11C | 48 | Ø1/2-13 NUT | N/A |
| 12 | 2 | CYLINDER MOUNT | FIG. 20A-20B |
| 12A | 8 | Ø1/2-13 HHCS - 2.00 LONG (BOLT) | N/A |
| 12B | 8 | Ø1/2 WASH E R | N/A |
| 12C | 4 | Ø1/2-13 HHCS - 2.00 LONG (BOLT) | N/A |
| 12D | 4 | Ø1/2-13 NUT | N/A |
| 13 | 4 | PIN HEAD | N/A |
| 13A | 4 | Ø 7/8-9 HHCS - 2.75 LONG (BOLT) | N/A |
| 13B | 8 | Ø 7/8 WASHER | N/A |
| 13C | 4 | Ø 7/8-9 NUT | N/A |
| 14 | 4 | CYLINDER PIN | N/A |
| 15 | 2 | RUBBER SEAL - TOP HANGAR DOOR | FIG. 21 |
| 16 | 2 | SEAL RETAINER - TOP HANGAR DOOR | FIG. 22A-22B |
| 16A | 8 | Ø1/4-20 HHCS - 1.00 LONG (BOLT) | N/A |
| 17 | 2 | RUBBER SEAL - MIDDLE | N/A |
| 18 | 2 | SEAL RETAINER - MIDDLE HANGAR DOOR | FIG. 23A-23B |
| 18A | 18 | Ø1/4-20 HHCS - 1.00 LONG (BOLT) | N/A |
| 19 | 2 | RUBBER SEAL - BOTTOM HANGAR DOOR | FIG. 24 |
| 20 | 2 | SEAL RETAINER - BOTTOM HANGAR DOOR | FIG. 25A-25B |
| 20A | 12 | Ø1/4-20 HHCS - 1.00 LONG (BOLT) | N/A |
| 21 | 2 | RUBBER SEAL - TOP CAP | FIG. 26 |
| 22 | 2 | SEAL RETAINER - TOP CAP | FIG. 27A-27B |
| 22A | 4 | Ø1/4-20 HHCS - 1.00 LONG (BOLT) | N/A |
| 23 | 1 | RUBBER SEAL - FLOOR | FIG. 30 |
| 24 | 5 | SEAL RETAINER - FLOOR | FIG. 28A-28B |
| 24A | 52 | Ø1/4-20 HHCS - 1.00 LONG (BOLT) | N/A |
| 25 | 2 | INTERNAL BRACE - VERTICAL | FIG. 29A-29B |
| 25A | 8 | Ø1/2-13 HHCS - 1.50 LONG (BOLT) | N/A |
| 25B | 8 | Ø1/2 WASHER | N/A |
| 25C | 8 | Ø1/2-13 NUT | N/A |
| 26 | 2 | HYDRAULIC CYLINDER | N/A |

As shown in Table 1, there are descriptions of components with quantity needed in addition to the figures that the part is shown in. Shown in the figures are the numbers 1527-1 through 1527-26. These numbers are shown in FIGS. 8 and 11 to be able to find the where the parts are positioned with respect to one another when all assembled, and the numbers 1527-# are shown next to the figure labels of these figures so as to see which 1527-# corresponds with which figure. For example, on the page that shows FIG. 24 is a rubber seal that goes near a bottom of the door 14 to seal off an interfacing between the frame 12 and the door 14 for a bottom portion of the hydraulic door 10. Shown next to FIG. 24 on the page of FIG. 24 is the corresponding 1527-# that can be found in FIG. 11 or FIG. 8. FIG. 24 shows the number 1527-19 next to the Figure label and thus to see where the rubber seal that is shown in FIG. 24 goes when together with the other parts and fully assembled, the number 1527-19 should be found. In FIG. 11, the number 1527-19 is shown at a bottom right corner of the figure, thus indicating where that part will be assembled.

Note that in Table 1, the “Ø” symbol refers to diameter size. It should also be noted that FIG. 11 includes a floor seal labeled as 1527-24.

From the foregoing, it can be seen that the present disclosure accomplishes at least all of the stated objectives.

1. A hydraulic door, comprising:
a frame, the frame comprising:
a horizontal portion;
two vertical portions positioned at each of a distal ends of the horizontal portion, and extending in a same direction from the horizontal portion;
wherein each of the two vertical portions comprise:
a post;
a foot at a bottom of the post;
a frame-V extending outwardly from an upper portion of the post shaped as a “V”, wherein an apex of a shape of the frame-V is positioned furthest away from the post; and
a shelf positioned on a lower portion of the post;
a door, the door comprising:
a top portion;
two side portions extending positioned at each of a distal ends of the top portion, and extending in a same direction from the top portion;
a bottom portion extending between the distal ends of the two side portions opposite the top portion; and
a plate positioned in between each of the top portion, the two side portions, and the bottom portion;
wherein each of the two side portions includes a door-V extending outwardly from an upper portion of the side portion shaped as a “V”, wherein an apex of a shape of the door-V is positioned furthest away from the side portion;
two mounts, wherein the two mounts are separately and removably attached to the two vertical portions adjacent the shelf of each of the two vertical portions, and the two mounts each include a plurality of elongated apertures on a base portion of the two mounts;
two bottom hydraulic pins, wherein the two bottom hydraulic pins separately extend through the two mounts;
two hydraulic cylinders, wherein the two hydraulic cylinders separately attach to the two bottom hydraulic pins;
two top hydraulic pins, wherein the two top hydraulic pins separately extend into the each of the door-V and the two hydraulic cylinders separately attach to the two top hydraulic pins; and
two pivot pins separately extending through each of the door-V and the frame-V, connecting the door-V and the frame-V on a first side of the hydraulic door, and connecting the door-V and the frame-V on a second side of the hydraulic door, and placing the door and the frame in rotational communication.

2. The hydraulic door of claim 1, further comprising greaseless bushings surrounding the pivot pins interfacing between the pivot pins and the door-V and the pivot pins and the frame-V.

3. The hydraulic door of claim 2, further comprising a pivot pin housing on the door-V and a pivot pin-housing on the frame-V to house the pivot pin over a portion of the pivot pin that extends between the door-V and the frame-V.

4. The hydraulic door of claim 1, further comprising a plurality of plates, a plurality of horizontal supports, and further comprising a plurality of vertical supports, wherein the plurality of horizontal supports and the plurality of vertical supports in combination form a grid-like structure in between the top portion, the two side portions, and the bottom portion for the plurality of plates to be positioned in between.

5. The hydraulic door of claim 1, further comprising top seals securely fastened to the two side portions of the door via top seal retainers, and bottom seals securely fastened to vertical portions of the frame via bottom seal retainers.

6. The hydraulic door of claim 5, wherein each of the top seal retainers and the bottom seal retainers comprise a sheet of material which sandwich the top seals and the bottom seals respectively to the door and the frame respectively in which bolts are inserted through the top seal retainer and the top seal to be secured to the door and bolts are inserted through the bottom seal retainer and the bottom seal to be secured to the frame, thus sealing an interface between the door and the frame when the door is in a closed position.

7. The hydraulic door of claim 1 further comprising a floor seal attached to the bottom portion for sealing an interfacing between a bottom of the door and the ground.

8. A kit for a hydraulic door, comprising:
a frame including:
a horizontal portion;
two vertical portions;
wherein each of the two vertical portions comprise:
a post;
a foot at a bottom of the post;
a frame-V extending outwardly from an upper portion of the post shaped as a “V”, wherein an apex of a shape of the frame-V is positioned furthest away from the post; and
a shelf positioned on a lower portion of the post;
a door including:
a top portion;
two side portions;
a bottom portion; and
a plate;
wherein each of the two side portions includes a door-V extending outwardly from an upper portion of the side portion shaped as a “V”, wherein an apex of a shape of the door-V is positioned furthest away from the side portion;
two mounts, the two mounts each comprising a base with two walls extending a same direction from the base, wherein the base includes a plurality of elongated apertures and each of the walls includes a pin aperture in coincident alignment with one another;
two bottom hydraulic pins;
two hydraulic cylinders;
two top hydraulic pins; and
two pivot pins.

9. The kit of claim 8 further comprising a floor seal.

10. The kit of claim 9, further comprising two top seals, two bottom seals, two top seal retainers, and two bottom seal retainers.

11. The kit of claim 8, further comprising a plurality of plates, plurality of horizontal supports, and a plurality of vertical supports.

12. The kit of claim 8, further comprising a plurality of linchpins.

13. The kit of claim 8, further comprising a plurality of greaseless bushings.
